(19) United States
(12) Patent Application Publication
(10) Pub. No.: US 2025/0302169 A1
(43) Pub. Date: Oct. 2, 2025

(54) SUITCASE TO HOLD ADULT MASSAGER AND SUITCASE WITH ADULT MASSAGER

(71) Applicant: Changhu ZHAN, Shenzhen City (CN)

(72) Inventor: Changhu ZHAN, Shenzhen City (CN)

(21) Appl. No.: 19/232,864

(22) Filed: Jun. 10, 2025

Related U.S. Application Data
(63) Continuation-in-part of application No. 18/815,838, filed on Aug. 27, 2024.

(51) Int. Cl. A45C 13/02; A45C 5/03; A45C 5/14; A45C 13/26; A61H 19/00

(52) U.S. Cl. CPC A45C 13/02; A45C 5/03; A45C 5/14; A45C 13/262; A45C 2013/267; A61H 19/32

(57) ABSTRACT

A suitcase to hold an adult massager, configured to hold an adult massager. The adult massager is made of silicone and has deformability, which includes a case body. The case body includes a first housing and a second housing, a first end of the first housing is rotatably connected to a first end of the second housing, the first housing is provided with a first containing groove, the second housing is provided with a second containing groove, the first containing groove is configured to allow a lower part of the adult massager to be inserted, the second containing groove is configured to allow an upper part of the adult massager to be inserted, and when the second housing covers the first housing, the first containing groove and the second containing groove are connected to form a containing space for completely accommodating the adult massage.

### CROSS-REFERENCE TO RELATED APPLICATIONS

This application is a Continuation-in-Part of the U.S. application Ser. No. 18/815,838 filed on Aug. 27, 2024, and entitled “SUITCASE BODY TO HOLD MASSAGER AND SUITCASE WITH MASSAGER” now pending, the entire disclosures of which are incorporated herein by reference.

### TECHNICAL FIELD

The present invention relates to containing devices, and in particular, to a suitcase to hold an adult massager and a suitcase with an adult massager.

### BACKGROUND OF THE INVENTION

The adult massager, as a massager in the sexual life of men and women, is an interesting massager which achieves sexual pleasure by massaging the whole body or part of the human body. With the emancipation of people's minds, more and more consumers choose to purchase and use this kind of massager.

However, when users transport and store adult massagers, it is easy for others to accidentally find such products, which inevitably causes embarrassment; especially in the army and schools, people have a low degree of privacy protection; even in their own homes, they may be accidentally found by visitors and children. At present, the existing adult massagers on the market generally use independent packages to avoid privacy invention, but such packages are difficult to reuse after disassembly, and their containing devices are generally special and easy to be noticed by others. Moreover, there are many large adult massagers made of silicone, which are prone to deformation and prone to adhering to dust. Therefore, there is an urgent need for an accommodating device for such products that can protect privacy, prevent the adult massager products from deforming, and effectively isolate dust and other impurities.

Therefore, the present invention provides a suitcase to hold an adult massager and a suitcase with an adult massager, which can effectively solve the above problems. It has a simple structure and convenient use, effectively protecting the privacy of users, avoiding attracting attention from others, and providing support for the adult massager to prevent deformation.

### SUMMARY OF THE INVENTION

The present invention provides a suitcase to hold an adult massager and a suitcase with an adult massager. It has a simple structure and convenient use, effectively protecting the privacy of users, avoiding attracting attention from others, and providing support for the adult massager to prevent deformation.

A suitcase to hold an adult massager, configured to hold an adult massager. The adult massager is made of silicone and has deformability, the suitcase to hold an adult massager includes a case body.

The case body includes a first housing and a second housing, a first end of the first housing is rotatably connected to a first end of the second housing, the first housing is provided with a first containing groove, the second housing is provided with a second containing groove, the first containing groove is configured to allow a lower part of the adult massager to be inserted, the second containing groove is configured to allow an upper part of the adult massager to be inserted, and when the second housing covers the first housing, the first containing groove and the second containing groove are connected to form a containing space for completely accommodating the adult massager; both the first containing groove and the second containing groove include side walls formed by curved surfaces and arranged symmetrically on left and right sides, the curved surfaces on the left and right sides extend downward from an upper end, gradually widen, then gradually narrow, and finally converge by extending upward from a bottom, the shape of the side walls simulates the shape of human buttocks and is suitable for supporting at least a part of the adult massager, thereby preventing deformation of the adult massager.

As an improvement of the present invention, the first housing is provided with a support member detachably inserted therein, at least a part of the first containing groove is disposed on the support member, and when the support member is detached from the first housing, it is configured to be positioned atop the case body to obliquely support the adult massager.

As an improvement of the present invention, a second end of the first housing is provided with a locking device, a second end of the second housing is provided with a locking hole, and a locking block of the locking device is detachably connected to the locking hole.

As an improvement of the present invention, the locking device includes an unlock button, the unlock button is configured to drive the locking block to be detached from the locking hole by an external force.

As an improvement of the present invention, the locking device includes a password adjusting part, and the password adjusting part is configured to lock or release the unlock button.

As an improvement of the present invention, the suitcase to hold an adult massager further includes a handle, the handle is arranged at the second end of the first housing and is configured for the user to grip.

As an improvement of the present invention, a first roller is arranged on one side of the first end of the first housing away from the second housing, and a second roller is arranged on one side of the first end of the second housing away from the first housing.

As an improvement of the present invention, the suitcase to hold an adult massager further includes a pull rod, a pull rod groove is arranged on one side of the first housing away from the second housing, the pull rod is slidably arranged in the pull rod groove, and is configured to penetrate into or out along the second end of the first housing.

As an improvement of the present invention, the pull rod includes a handgrip and a rod body, the first housing is provided with a handgrip groove adjacent to the pull rod groove, the rod body is configured to slide within the pull rod groove, and the handgrip is detachably accommodated in the handgrip groove.

As an improvement of the present invention, a diameter of a middle of the handgrip is greater than a diameter of each of two ends of the handgrip.

The present invention also provides a suitcase with an adult massager, which includes an adult massager and a case body.

The adult massager is made of silicone and has deformability, the case body includes a first housing and a second housing, a first end of the first housing is rotatably connected to a first end of the second housing, the first housing is provided with a first containing groove, the second housing is provided with a second containing groove, the first containing groove is configured to allow a lower part of the adult massager to be inserted, the second containing groove is configured to allow an upper part of the adult massager to be inserted, and when the second housing covers the first housing, the first containing groove and the second containing groove are connected to form a containing space for completely accommodating the adult massager; the shape of the first containing groove matches the shape of the lower part of the adult massager, and the shape of the second containing groove matches the shape of the upper part of the adult massager; both the first containing groove and the second containing groove include side walls formed by curved surfaces and arranged symmetrically on left and right sides, the curved surfaces on the left and right sides extend downward from an upper end, gradually widen, then gradually narrow, and finally converge by extending upward from a bottom, the shape of the side walls simulates the shape of human buttocks and is suitable for supporting at least a part of the adult massager, thereby preventing deformation of the adult massager.

As an improvement of the present invention, the first housing is provided with a support member detachably inserted therein, at least a part of the first containing groove is disposed on the support member, when the support member is detached from the first housing and is positioned atop the case body, the adult massager is obliquely disposed on the support member, and the support member provides support for the adult massager.

As an improvement of the present invention, a second end of the first housing is provided with a locking device, a second end of the second housing is provided with a locking hole, and a locking block of the locking device is detachably connected to the locking hole.

As an improvement of the present invention, the locking device includes an unlock button, and the unlock button is configured to drive the locking block to be detached from the locking hole by an external force.

As an improvement of the present invention, the locking device includes a password adjusting part, and the password adjusting part is configured to lock or release the unlock button.

As an improvement of the present invention, the suitcase with an adult massager further includes a handle. The handle is arranged at the second end of the first housing and is configured for the user to grip.

As an improvement of the present invention, a first roller is arranged on one side of the first end of the first housing away from the second housing, and a second roller is arranged on one side of the first end of the second housing away from the first housing.

As an improvement of the present invention, the suitcase with an adult massager further includes a pull rod, a pull rod groove is arranged on one side of the first housing away from the second housing, the pull rod is slidably arranged in the pull rod groove, and is configured to penetrate into or out along the second end of the first housing.

As an improvement of the present invention, the pull rod includes a handgirp and a rod body, the first housing is provided with a handgirp groove adjacent to the pull rod groove, the rod body is configured to slide within the pull rod groove, and the handgirp is detachably accommodated in the handgirp groove.

As an improvement of the present invention, a diameter of a middle of the handgirp is greater than a diameter of each of two ends of the handgirp.

Beneficial effects: through the arrangement of the above structure, when in use, a user is able to insert the lower part of the adult massager into the first containing groove and cover the second housing, so that the upper part of the adult massager is inserted into the second containing groove, effectively accommodating and shielding the adult massager. On the one hand, the cleanliness of the adult massager can be ensured. On the other hand, the adult massager can be hidden in the suitcase, making it less likely to be noticed during transportation and storage. The privacy of the user is effectively protected, and the embarrassing situation where the adult massager is accidentally discovered by others is avoided.

### BRIEF DESCRIPTION OF DRAWINGS

In order to explain the technical solutions of the embodiments of the present invention more clearly, the following will briefly introduce the accompanying drawings used in the embodiments. The drawings in the following description are only some embodiments of the present invention. Those of ordinary skill in the art can obtain other drawings based on these drawings without creative work.

The present invention is further described below in detail in combination with the accompanying drawings and embodiments.

FIG. 1 is a schematic diagram of the overall structure of a first embodiment of the present invention in the closed state;

FIG. 2 is a schematic diagram of the overall structure of the first embodiment of the present invention in the opened state;

FIG. 3 is a schematic diagram of the exploded structure of the first embodiment of the present invention in the closed state;

FIG. 4 is a schematic diagram of the structure of the first embodiment of the present invention in the state of the pull rod being stretched;

FIG. 5 is a schematic sectional structure diagram of the first embodiment of the present invention;

FIG. 6 is a schematic diagram of the first embodiment of the present invention in use state;

FIG. 7 is a schematic diagram of the partial structure of a second embodiment of the present invention; and

FIG. 8 is a schematic diagram of the second embodiment of the present invention in use state.

### DETAILED DESCRIPTION OF THE INVENTION

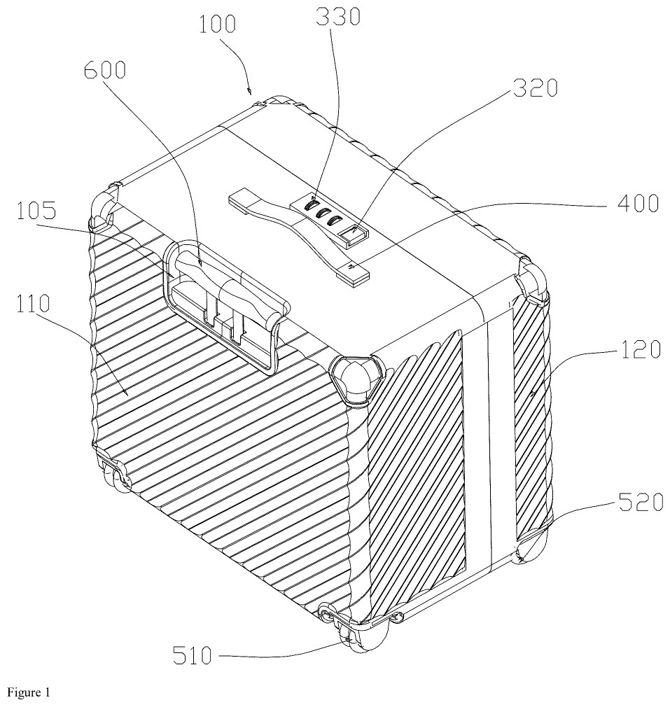

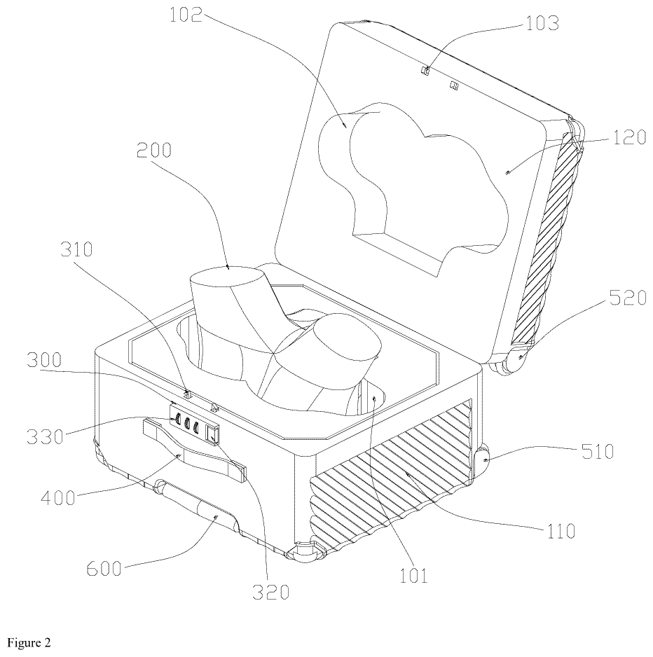

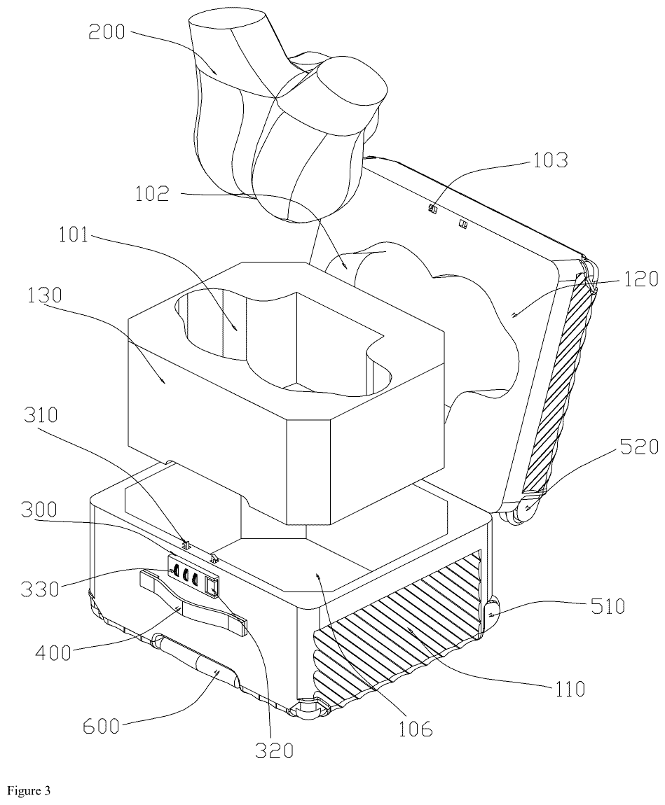

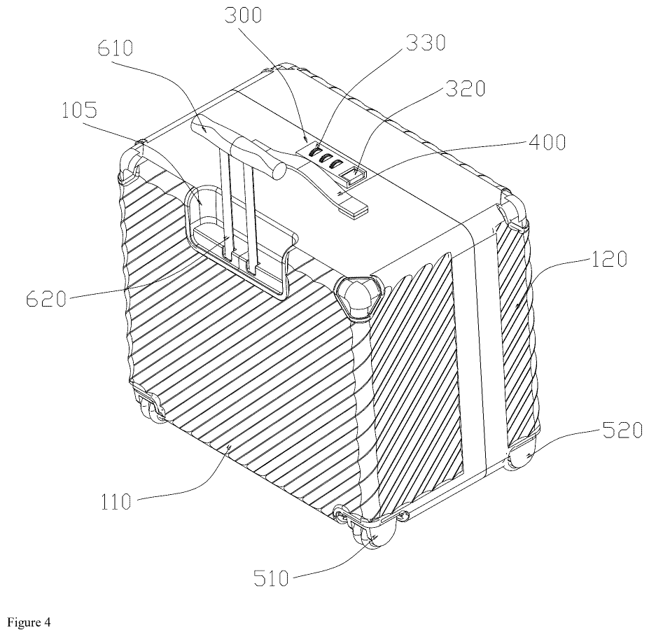

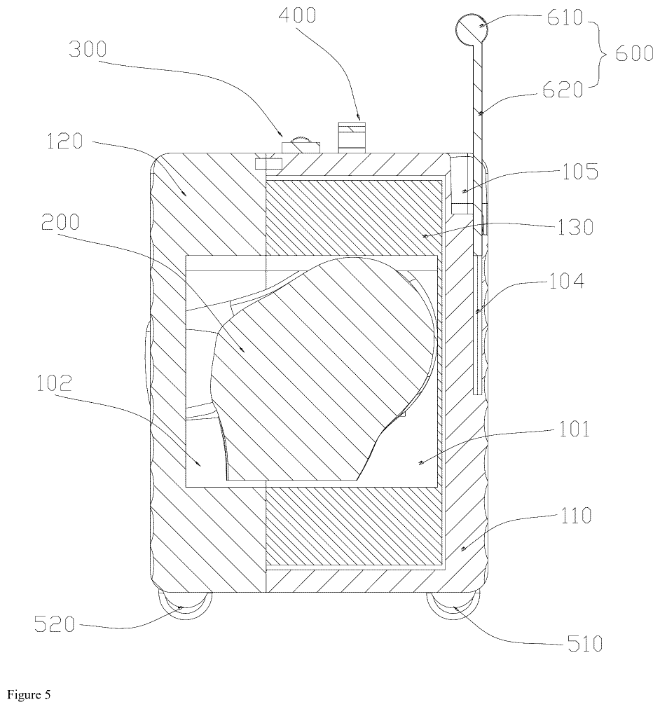

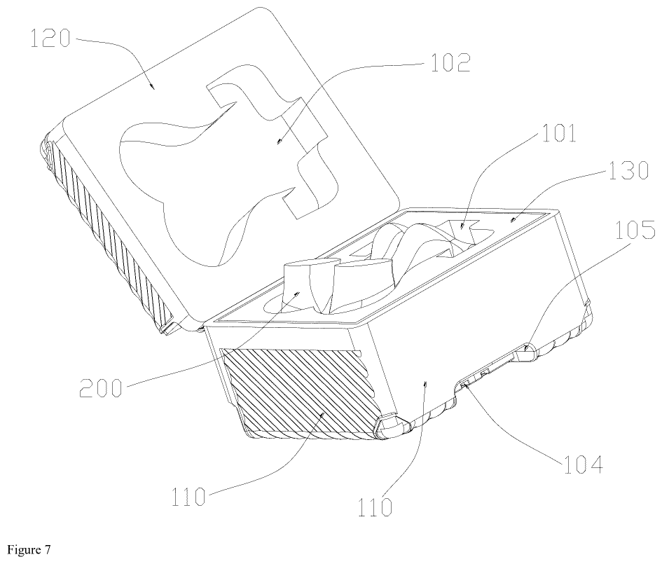

Referring to FIG. 1 to FIG. 8, a suitcase to hold an adult massager is used to hold an adult massager 200. The adult massager is made of silicone and has deformability, and the suitcase includes a case body 100. The case body 100 includes a first housing 110 and a second housing 120, a first end of the first housing 110 is rotatably connected to a first end of the second housing 120, the first housing 110 is provided with a first containing groove 101, the second housing 120 is provided with a second containing groove 102, the first containing groove 101 is configured to allow a lower part of the adult massager 200 to be inserted, the second containing groove 102 is configured to allow an upper part of the adult massager 200 to be inserted, and when the second housing 120 covers the first housing 110, the first containing groove 101 and the second containing groove 102 are connected to form an containing space for completely accommodating the adult massager 200; both the first containing groove 101 and the second containing groove 102 include side walls formed by curved surfaces and arranged symmetrically on left and right sides, the curved surfaces on the left and right sides extend downward from an upper end, gradually widen, then gradually narrow, and finally converge by extending upward from a bottom, the shape of the side walls simulates the shape of human buttocks and is suitable for supporting at least a part of the adult massager 200, thereby preventing deformation of the adult massager 200.

Through the arrangement of the above structure, when in use, a user is able to insert the lower part of the adult massager 200 into the first containing groove 101 and cover the second housing 120, so that the upper part of the adult massager 200 is inserted into the second containing groove 102, effectively accommodating and shielding the adult massager 200. On the one hand, the cleanliness of the adult massager 200 can be ensured. On the other hand, the adult massager 200 can be hidden in the suitcase, making it less likely to be noticed during transportation and storage. The privacy of the user is effectively protected, and the embarrassing situation where the adult massager 200 is accidentally discovered by others is avoided.

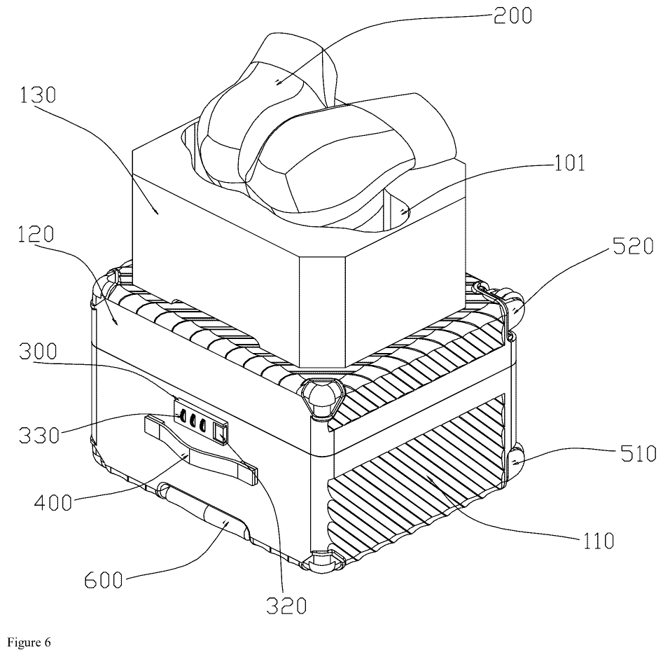

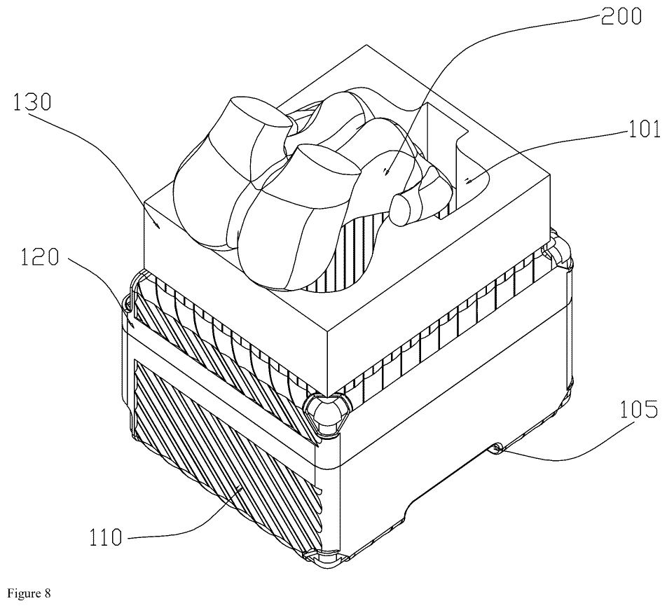

In this embodiment, the first housing 110 is provided with a support member 130 detachably inserted therein, at least a part of the first containing groove 101 is disposed on the support member 130, and when the support member 130 is detached from the first housing 110, it is configured to be positioned atop the case body 100 to obliquely support the adult massager 200. Through the arrangement of the above structure, when in use, the support member is removed from and disposed on the case body 100, and then the adult massager 200 is obliquely disposed on the support member 130, as shown in FIGS. 6 and 8. At this time, the upper part of the adult massager 200 is received in the first containing groove 101, effectively fixing the adult massager 200, while the functional area of the lower part of the adult massager 200 is exposed for convenient user operation. Moreover, supporting the adult massager 200 with the support member 130 can prevent the lower part of the adult massager 200 from being contaminated by dust and other debris, ensuring the cleanliness of the adult massager 200.

In this embodiment, a second end of the first housing 110 is provided with a locking device 300, a second end of the second housing 120 is provided with a locking hole 103, and a locking block 310 of the locking device 300 is detachably connected to the locking hole 103. Through the arrangement of the above structure, when in use, the locking block 310 is locked in the locking hole 103, enabling the second ends of the first housing 110 and the second housing 120 to be locked together. This prevents the case body 100 from being opened accidentally, further ensuring the stability of the product and safeguarding the user's privacy from being disclosed. When opening the second housing 120, the locking block 310 is detached from the locking hole 103 to open the case body 100, thereby enabling the user to conveniently take and clean the adult massager 200.

In this embodiment, the locking device 300 includes an unlock button 320, and the unlock button 320 is configured to drive the locking block 310 to be detached from the locking hole 103 by an external force. Through the arrangement of the above structure, when in use, the user is able to press the unlock button 320, and the unlock button 320 drives the locking block 310 to be detached from the locking hole 103, so that the second end of the first housing 110 is detached from the second end of the second housing 120, thereby enabling the user to conveniently open the case body 100. It is convenient to use and simple to operate.

In this embodiment, the locking device 300 includes a password adjusting part 330, and the password adjusting part 330 is configured to lock or release the unlock button 320. Through the arrangement of the above structure, when in use, by adjusting the password adjusting part 330, the real-time password is made the same as the preset password. At this time, the password adjusting part 330 releases the unlock button 320. Then, when the user presses the unlock button 320, the locking block 310 is able to be detached from the locking hole 103, so that the second housing 120 and the first housing 110 are detached, and the case body 100 is opened. However, when locking is required, by adjusting the password adjusting part 330, the real-time password is made different from the preset password, and the password adjusting part 330 locks the unlock button 320. At this time, the locking block 310 is inserted into the locking hole 103 to fix the second housing 120 and the first housing 110, effectively preventing the case body 100 from being opened accidentally and protecting the privacy of the users.

In this embodiment, a handle 400 is further included. The handle 400 is arranged at the second end of the first housing 110 and is configured for the user to grip. When in use, the user is able to grip the handle 400, which facilitates convenient picking up and transporting of the product. This design enhances convenience, improves the portability of the product, and provides a better user experience.

In this embodiment, a first roller 510 is arranged on one side of the first end of the first housing 110 away from the second housing 120, and a second roller 520 is arranged on one side of the first end of the second housing 120 away from the first housing 110. Through the arrangement of the above structure, the first roller 510 is arranged at the bottom of the first housing 110, and the second roller 520 is arranged at the bottom of the second housing 120. When in use, the first roller 510 and the second roller 520 are in contact with the ground, enabling the user to push or pull the product in a more labor-saving manner, thereby improving the convenience of use.

In this embodiment, a pull rod 600 is further included. A pull rod groove 104 is arranged on one side of the first housing 110 away from the second housing 120, and the pull rod 600 is slidably arranged in the pull rod groove 104 and is configured to penetrate into or out along the second end of the first housing 110. Through the arrangement of the above structure, when in use, the pull rod 600 is able to be partially pulled out from the pull rod groove 104, enabling the user to adjust the height of the end of the pull rod 600, thereby facilitating the pulling of the product and enhancing ease of use. However, when storing the product, the pull rod 600 is substantially completely inserted into the pull rod groove 104, reducing the overall length of the product and decreasing the product volume, which is convenient for storage and transportation. Preferably, the pull rod 600 is provided with a spring buckle, and several locking positions are provided in the pull rod groove 104. The spring buckle is clamped to different locking positions, which can adjust the extended length of the pull rod 600, ensuring the stability of the product structure.

In this embodiment, the pull rod 600 includes a handgrip 610 and a rod body 620. The first housing 110 is provided with a handgrip groove 105 adjacent to the pull rod groove 104. The rod body 620 can slide within the pull rod groove 104, and the handgrip 610 is detachably accommodated in the handgrip groove 105. Through the arrangement of the above structure, the user can pull or press the handgrip 610 to extend or retract the rod body 620, enabling the user to conveniently adjust the extension length of the pull rod 600. When pulling the product, the handgrip 610 provides a convenient grip for the user, enhancing the user's convenience. During storage, the handgrip 610 is pressed down so that the rod body 620 is substantially completely inserted into the pull rod groove 104, and the handgrip 610 is accommodated in the handgrip groove 105, thereby effectively reducing the volume of the product.

In this embodiment, the diameter of the middle of the handgrip 610 is greater than the diameter of each of the two ends of the handgrip 610. Through the arrangement of the above structure, the handgrip 610 is thicker in the middle and thinner at both ends, providing the user with a more comfortable hand feel when gripping the handgrip 610, thereby enhancing the user experience.

Referring to FIG. 1 to FIG. 8, a suitcase with an adult massager includes an adult massager 200 and a case body 100. The adult massager 200 is made of silicone and has deformability. The case body 100 includes a first housing 110 and a second housing 120, a first end of the first housing 110 is rotatably connected to a first end of the second housing 120, the first housing 110 is provided with a first containing groove 101, the second housing 120 is provided with a second containing groove 102, the first containing groove 101 is configured to allow a lower part of the adult massager 200 to be inserted, the second containing groove 102 is configured to allow an upper part of the adult massager 200 to be inserted, and when the second housing 120 covers the first housing 110, the first containing groove 101 and the second containing groove 102 are connected to form a containing space for completely accommodating the adult massager 200; the shape of the first containing groove 101 matches the shape of the lower part of the adult massager 200, and the shape of the second containing groove 102 matches the shape of the upper part of the adult massager 200; both the first containing groove 101 and the second containing groove 102 include side walls formed by curved surfaces and arranged symmetrically on left and right sides, the curved surfaces on the left and right sides extend downward from an upper end, gradually widen, then gradually narrow, and finally converge by extending upward from a bottom, the shape of the side walls simulates the shape of human buttocks and is suitable for supporting at least a part of the adult massager 200, thereby preventing deformation of the adult massager 200. Through the arrangement of the above structure, when in use, a user is able to insert the lower part of the adult massager 200 into the first containing groove 101 and cover the second housing 120, so that the upper part of the adult massager 200 is inserted into the second containing groove 102, effectively accommodating and shielding the adult massager 200. On the one hand, the cleanliness of the adult massager 200 can be ensured. On the other hand, the adult massager 200 can be hidden in the suitcase, making it less likely to be noticed during transportation and storage. The privacy of the user is effectively protected, and the embarrassing situation where the adult massager 200 is accidentally discovered by others is avoided.

In this embodiment, the first housing 110 is provided with a support member 130 detachably inserted therein, at least part of the first containing groove 101 is disposed on the support member 130. When the support member 130 is detached from the first housing 110 and positioned atop the case body 100, the adult massager 200 is obliquely disposed on the support member 130, and the support member 130 provides support for the adult massager 200. Through the arrangement of the above structure, when in use, the support member is removed from and disposed on the case body 100, and then the adult massager 200 is obliquely disposed on the support member 130, as shown in FIGS. 6 and 8. At this time, the upper part of the adult massager 200 is received in the first containing groove 101, effectively fixing the adult massager 200, while the functional area of the lower part of the adult massager 200 is exposed for convenient user operation. Moreover, supporting the adult massager 200 with the support member 130 can prevent the lower part of the adult massager 200 from being contaminated by dust and other debris, ensuring the cleanliness of the adult massager 200.

In this embodiment, a second end of the first housing 110 is provided with a locking device 300, a second end of the second housing 120 is provided with a locking hole 103, and a locking block 310 of the locking device 300 is detachably connected to the locking hole 103. Through the arrangement of the above structure, when in use, the locking block 310 is locked in the locking hole 103, enabling the second ends of the first housing 110 and the second housing 120 to be locked together. This prevents the case body 100 from being opened accidentally. further ensuring the stability of the product and safeguarding the user's privacy from being disclosed. When opening the second housing 120, the locking block 310 is detached from the locking hole 103 to open the case body 100, thereby enabling the user to conveniently take and clean the adult massager 200.

In this embodiment, the locking device 300 includes an unlock button 320, and the unlock button 320 is configured to drive the locking block 310 to be detached from the locking hole 103 by an external force. Through the arrangement of the above structure, when in use, the user is able to press the unlock button 320, and the unlock button 320 drives the locking block 310 to disengage from the locking hole 103, so that the second end of the first housing 110 is detached from the second end of the second housing 120, thereby enabling the user to conveniently open the case body 100. It is convenient to use and simple to operate.

In this embodiment, the locking device 300 includes a password adjusting part 330, and the password adjusting part 330 is configured to lock or release the unlock button 320. Through the arrangement of the above structure, when in use, by adjusting the password adjusting part 330, the real-time password is made the same as the preset password. At this time, the password adjusting part 330 releases the unlock button 320. Then, when the user presses the unlock button 320, the locking block 310 is able to be detached from the locking hole 103, so that the second housing 120 and the first housing 110 are detached, and the case body 100 is opened. However, when locking is required, by adjusting the password adjusting part 330, the real-time password is made different from the preset password, and the password adjusting part 330 locks the unlock button 320. At this time, the locking block 310 is inserted into the locking hole 103 to fix the second housing 120 and the first housing 110, effectively preventing the case body 100 from being opened accidentally and protecting the privacy of the users.

In this embodiment, a handle 400 is further included. The handle 400 is arranged at the second end of the first housing 110 and is configured for the user to grip. When in use, the user is able to grip the handle 400, which facilitates convenient picking up and transporting of the product. This design enhances convenience, improves the portability of the product, and provides a better user experience.

In this embodiment, a first roller 510 is arranged on one side of the first end of the first housing 110 away from the second housing 120, and a second roller 520 is arranged on one side of the first end of the second housing 120 away from the first housing 110. Through the arrangement of the above structure, the first roller 510 is arranged at the bottom of the first housing 110, and the second roller 520 is arranged at the bottom of the second housing 120. When in use, the first roller 510 and the second roller 520 are in contact with the ground, enabling the user to push or pull the product in a more labor-saving manner, thereby improving the convenience of use.

In this embodiment, a pull rod 600 is further included. A pull rod groove 104 is arranged on one side of the first housing 110 away from the second housing 120, and the pull rod 600 is slidably arranged in the pull rod groove 104 and is configured to penetrate into or out along the second end of the first housing 110. Through the arrangement of the above structure, when in use, the pull rod 600 is able to be partially pulled out from the pull rod groove 104, enabling the user to adjust the height of the end of the pull rod 600, thereby facilitating the pulling of the product and enhancing ease of use. However, when storing the product, the pull rod 600 is substantially completely inserted into the pull rod groove 104, reducing the overall length of the product and decreasing the product volume, which is convenient for storage and transportation. Preferably, the pull rod 600 is provided with a spring buckle, and several locking positions are provided in the pull rod groove 104. The spring buckle is clamped to different locking positions, which can adjust the extended length of the pull rod 600, ensuring the stability of the product structure.

In this embodiment, the pull rod 600 includes a handgrip 610 and a rod body 620. The first housing 110 is provided with a handgrip groove 105 adjacent to the pull rod groove 104. The rod body 620 can slide within the pull rod groove 104, and the handgrip 610 is detachably accommodated in the handgrip groove 105. Through the arrangement of the above structure, the user can pull or press the handgrip 610 to extend or retract the rod body 620, enabling the user to conveniently adjust the extension length of the pull rod 600. When pulling the product, the handgrip 610 provides a convenient grip for the user, enhancing the user's convenience. During storage, the handgrip 610 is pressed down so that the rod body 620 is substantially completely inserted into the pull rod groove 104, and the handgrip 610 is accommodated in the handgrip groove 105, thereby effectively reducing the volume of the product.

In this embodiment, the diameter of the middle of the handgrip 610 is greater than the diameter of each of the two ends of the handgrip 610. Through the arrangement of the above structure, the handgrip 610 is thicker in the middle and thinner at both ends, providing the user with a more comfortable hand feel when gripping the handgrip 610, thereby enhancing the user experience.

As described above, one or more embodiments are provided in conjunction with the detailed description, The specific implementation of the present invention is not confirmed to be limited to that the description is similar to or similar to the method, the structure and the like of the present invention, or a plurality of technical deductions or substitutions are made on the premise of the conception of the present invention to be regarded as the protection of the present invention.

1. A suitcase to hold an adult massager, configured to hold an adult massager (200), wherein the adult massager (200) is made of silicone and has deformability, comprising: a case body (100), wherein the case body (100) comprises a first housing (110) and a second housing (120), a first end of the first housing (110) is rotatably connected to a first end of the second housing (120), the first housing (110) is provided with a first containing groove (101), the second housing (120) is provided with a second containing groove (102), the first containing groove (101) is configured to allow a lower part of the adult massager (200) to be inserted, the second containing groove (102) is configured to allow an upper part of the adult massager (200) to be inserted, and when the second housing (120) covers the first housing (110), the first containing groove (101) and the second containing groove (102) are connected to form a containing space for completely accommodating the adult massager (200); both the first containing groove (101) and the second containing groove (102) comprise side walls formed by curved surfaces and arranged symmetrically on left and right sides, the curved surfaces on the left and right sides extend downward from an upper end, gradually widen, then gradually narrow, and finally converge by extending upward from a bottom, a shape of the side walls simulates a shape of human buttocks and is suitable for supporting at least a part of the adult massager (200), thereby preventing deformation of the adult massager (200).

2. The suitcase to hold an adult massager according to claim 1, wherein the first housing (110) is provided with a support member (130) detachably inserted therein, at least a part of the first containing groove (101) is disposed on the support member (130), and when the support member (130) is detached from the first housing (110), it is configured to be positioned atop the case body (100) to obliquely support the adult massager (200).

3. The suitcase to hold an adult massager according to claim 1, wherein a second end of the first housing (110) is provided with a locking device (300), a second end of the second housing (120) is provided with a locking hole (103), and a locking block (310) of the locking device (300) is detachably connected to the locking hole (103).

4. The suitcase to hold an adult massager according to claim 3, wherein the locking device (300) comprises an unlock button (320), the unlock button (320) is configured to drive the locking block (310) to be detached from the locking hole (103) by an external force.

5. The suitcase to hold an adult massager according to claim 4, wherein the locking device (300) comprises a password adjusting part (330), and the password adjusting part (330) is configured to lock or release the unlock button (320).

6. The suitcase to hold an adult massager according to claim 1, further comprising a handle (400), wherein the handle (400) is arranged at the second end of the first housing (110) and is configured for a user to grip.

7. The suitcase to hold an adult massager according to claim 1, wherein a first roller (510) is arranged on one side of the first end of the first housing (110) away from the second housing (120), and a second roller (520) is arranged on one side of the first end of the second housing (120) away from the first housing (110).

8. The suitcase to hold an adult massager according to claim 1, further comprising a pull rod (600), wherein a pull rod groove (104) is arranged on one side of the first housing (110) away from the second housing (120), the pull rod (600) is slidably arranged in the pull rod groove (104), and is configured to penetrate into or out along the second end of the first housing (110).

9. The suitcase to hold an adult massager according to claim 8, wherein the pull rod (600) comprises a handgrip (610) and a rod body (620), the first housing (110) is provided with a handgrip groove (105) adjacent to the pull rod groove (104), the rod body (620) is configured to slide within the pull rod groove (104), and the handgrip (610) is detachably accommodated in the handgrip groove (105).

10. The suitcase to hold an adult massager according to claim 9, wherein a diameter of a middle of the handgrip (610) is greater than a diameter of each of two ends of the handgrip (610).

11. A suitcase with an adult massager, comprising:
an adult massager (200) and
a case body (100),
wherein the adult massager (200) is made of silicone and has deformability, the case body (100) comprises a first housing (110) and a second housing (120), a first end of the first housing (110) is rotatably connected to a first end of the second housing (120), the first housing (110) is provided with a first containing groove (101), the second housing (120) is provided with a second containing groove (102), the first containing groove (101) is configured to allow a lower part of the adult massager (200) to be inserted, the second containing groove (102) is configured to allow an upper part of the adult massager (200) to be inserted, and when the second housing (120) covers the first housing (110), the first containing groove (101) and the second containing groove (102) are connected to form a containing space for completely accommodating the adult massager (200); a shape of the first containing groove (101) matches a shape of the lower part of the adult massager (200), and a shape of the second containing groove (102) matches a shape of the upper part of the adult massager (200); both the first containing groove (101) and the second containing groove (102) comprise side walls formed by curved surfaces and arranged symmetrically on left and right sides, the curved surfaces on the left and right sides extend downward from an upper end, gradually widen, then gradually narrow, and finally converge by extending upward from a bottom, a shape of the side walls simulates a shape of human buttocks and is suitable for supporting at least a part of the adult massager (200), thereby preventing deformation of the adult massager (200).

12. The suitcase with an adult massager according to claim 11, wherein the first housing (110) is provided with a support member (130) detachably inserted therein, at least a part of the first containing groove (101) is disposed on the support member (130), when the support member (130) is detached from the first housing (110) and is positioned atop the case body (100), the adult massager (200) is obliquely disposed on the support member (130), and the support member (130) provides support for the adult massager (200).

13. The suitcase with an adult massager according to claim 11, wherein a second end of the first housing (110) is provided with a locking device (300), a second end of the second housing (120) is provided with a locking hole (103), and a locking block (310) of the locking device (300) is detachably connected to the locking hole (103).

14. The suitcase with an adult massager according to claim 13, wherein the locking device (300) comprises an unlock button (320), the unlock button (320) is configured to drive the locking block (310) to be detached from the locking hole (103) by an external force.

15. The suitcase with an adult massager according to claim 14, wherein the locking device (300) comprises a password adjusting part (330), and the password adjusting part (330) is configured to lock or release the unlock button (320).

16. The suitcase with an adult massager according to claim 11, further comprising a handle (400), wherein the handle (400) is arranged at the second end of the first housing (110) and is configured for the user to grip.

17. The suitcase with an adult massager according to claim 11, wherein a first roller (510) is arranged on one side of the first end of the first housing (110) away from the second housing (120), and a second roller (520) is arranged on one side of the first end of the second housing (120) away from the first housing (110).

18. The suitcase with an adult massager according to claim 11, further comprising a pull rod (600), wherein a pull rod groove (104) is arranged on one side of the first housing (110) away from the second housing (120), the pull rod (600) is slidably arranged in the pull rod groove (104), and is configured to penetrate into or out along the second end of the first housing (110).

19. The suitcase with an adult massager according to claim 18, wherein the pull rod (600) comprises a handgrip (610) and a rod body (620), the first housing (110) is provided with a handgrip groove (105) adjacent to the pull rod groove (104), the rod body (620) is configured to slide within the pull rod groove (104), and the handgrip (610) is detachably accommodated in the handgrip groove (105).

20. The suitcase with an adult massager according to claim 19, wherein a diameter of a middle of the handgrip (610) is greater than a diameter of each of two ends of the handgrip (610).
